(19) United States
(12) Patent Application Publication
(10) Pub. No.: US 2013/0225803 A1
(43) Pub. Date: Aug. 29, 2013

(54) METHOD FOR PREPARING HYDROXYALKYL STARCH

(71) Applicants: Pil Nam Hong, Daegu (KR); Chang Heon Koh, Incheon (KR)

(72) Inventors: Pil Nam Hong, Daegu (KR); Chang Heon Koh, Incheon (KR)

(73) Assignee: SAMYANG GENEX CORPORATION, Seoul (KR)

(21) Appl. No.: 13/882,945

(22) PCT Filed: Nov. 23, 2011
(86) PCT No.: PCT/KR2011/008984

§ 371 Date: May 1, 2013

(30) Foreign Application Priority Data
Dec. 29, 2010 (KR) 10-2010-0137551

(51) Int. Cl. C08B 31/10

(52) U.S. Cl. CPC C08B 31/10
USPC 536/111

(57) ABSTRACT

The present invention relates to a method for preparing hydroxyalkyl starch. The method for preparing hydroxyalkyl starch comprises the steps of hydrolyzing starch, reducing the hydrolyzed starch, and substituting the reduced starch with hydroxyalkyl group in a dry process.

### TECHNICAL FIELD

The present invention relates to a method for preparing hydroxyalkyl starch. More specifically, the present invention relates to a method for preparing hydroxyalkyl starch which can control viscosity, and has improved physical properties of thermostability and alkali resistance, and color.

### BACKGROUND ART

Starch, which is a natural molecule having a high molecular weight, has a wide variety of use such as thickener, gelling agent, stabilizer, binding agent, humectant, excipient, binder in various industrial fields such as food, paper-manufacturing, fiber and pharmaceuticals. However, starch itself is limited in terms of its physical properties, so that modified starches—in which the intrinsic structure or physical property is changed—are prepared for application to various industrial fields. Among them, hydroxyalkyl starch is soluble in cold water, and thus it is used in various applications such as adhesive, binder, thickener, emulsion stabilizer, fiber-sizing agent, paper coating agent and the like, and sometimes is needed to meet requirements for proper viscosity and color depending on its use.

However, when starch is hydrolyzed via treatment such as acid treatment to control viscosity, the hydrolyzed starch has a problem in lowering the stability of gelatinized solution—e.g., easy retrogradation and formation of strong gel—compared with untreated starch. In addition, because hydrolyzed starch—which is treated such as acid treatment for controlling viscosity—exists as reducing sugar due to aldehyde group at the broken chain terminal, it may be easily colored, may be browned by the reaction with protein or amino acid, and may be yellowed or browned in case of heating at high temperature for a long time.

### DISCLOSURE OF INVENTION

### Technical Problem

To resolve the above problems, the present invention provides a method for preparing hydroxyalkyl starch which can control viscosity, and has improved physical properties of thermostability and alkali resistance, and color.

### Solution to Problem

The method for preparing hydroxyalkyl starch according to the present invention comprises the steps of hydrolyzing starch, reducing the hydrolyzed starch, and substituting the reduced starch with hydroxyalkyl group in a dry process.

The hydrolysis may be carried out by acid treatment, and the acid may be selected from hydrochloric acid, sulfuric acid, oxalic acid and a mixture thereof. The acid amount of the treatment may be 0.1-1 part by weight based on 100 parts by weight of the dry weight of the starch.

The method for preparing hydroxyalkyl starch may further comprise the step of bleaching the hydrolyzed starch prior to the reduction step. The bleaching may be carried out with a bleaching agent selected from the group consisting of sodium metabisulfite, hydrogen peroxide and sodium hypochlorite.

The reduction may be carried out by adding hydrogen gas generated by a reducing agent to the starch. The reducing agent may be selected from sodium borohydride, hydrogen, sulfur dioxide and a mixture thereof. The amount of the reducing agent may be 0.1-1 part by weight based on 100 parts by weight of the dry weight of the starch.

The dry substitution may be carried out by drying the reduced starch, treating the dried starch with an alkaline catalyst, and etherifying the alkaline catalyst-treated starch. The alkaline catalyst may be prepared by mixing aliphatic glycol and alkali solution in the amount ratio of 1:1 to 1:5. The aliphatic glycol may be selected from propylene glycol, ethylene glycol, butylene glycol, diethylene glycol and dipropylene glycol. The alkali solution may be 50% sodium hydroxide solution or potassium hydroxide solution.

### Advantageous Effects of Invention

According to the present invention, hydroxyalkyl starch—which can control viscosity depending on its use, and has improved color and physical properties such as viscosity stability of gelatinized solution, thermostability and alkali resistance—can be prepared. Specifically, the hydroxyalkyl starch is excellent in thermostability and color improvement, so that the whiteness of the hydroxyalkyl starch itself can be improved. In addition, the gelatinized solution prepared from the hydroxyalkyl starch has no problem such as color change and viscosity instability even when it is heated at high temperature for a long time. As a result, the hydroxyalkyl starch according to the present invention can be applied in various uses.

### BRIEF DESCRIPTION OF DRAWINGS

FIG. 1 is a photograph showing the color of starch before heating, and FIG. 2 is a photograph showing the color of starch after heating (left: hydrolyzed starch; middle: bleached starch; right: reduced starch).

FIG. 3 is a photograph showing the color of hydroxypropyl starch prepared from a waxy corn and a modified waxy corn before heating, and FIG. 4 is a photograph showing the color of hydroxypropyl starch prepared from a waxy corn and a modified waxy corn after heating (left: waxy corn; right: modified waxy corn).

### MODE FOR THE INVENTION

Hereinafter, the present invention is described in detail.

The method for preparing hydroxyalkyl starch according to the present invention comprises the steps of: hydrolyzing starch; reducing the hydrolyzed starch; and substituting the reduced starch with a hydroxyalkyl group in a dry process.

Hereinafter, each step is explained more specifically.

Hydrolysis Step

The method for preparing hydroxyalkyl starch according to the present invention comprises the step of hydrolyzing starch.

The starch, for example, may be corn starch, waxy corn starch, tapioca starch, potato starch, sweet potato starch or wheat starch. More preferably, the starch may be corn starch, waxy corn starch or tapioca starch.

The hydrolysis may be carried out by treating the starch with an acid. After an aqueous starch is prepared by dissolving the starch in water, the starch may be hydrolyzed by treatment with an acid such as hydrochloric acid, sulfuric acid, oxalic acid or a mixture thereof at below gelatinization temperature—in which starch granules do not swell in a slurry phase—for several hours. For example, after 1,000 g of starch (12 wt % of water content, 880 g of dry weight) is dissolved in 1,600 g of water, the obtained aqueous starch may be hydrolyzed by treating with 10 g of 35%(w/v) hydrochloric acid and maintained at 35-45° C. for 2-8 hours. By the hydrolysis, starch—which maintains its granule phase due to a low degree of degradation, is almost insoluble in cold water, and has a low degree of polymerization—can be formed. Most preferably, hydrochloric acid may be used in the acid treatment.

In the acid treatment, starch having a desired viscosity may be prepared by adjusting the acid amount of the treatment, reaction temperature of aqueous starch and reaction time. If the acid amount of the treatment and temperature remain constant, the viscosity of the starch is lowered according to the lengthy of the reaction time since hydrolysis further proceeds. If the reaction temperature and reaction time remain constant, the viscosity of the starch is lowered according to the increase of the acid amount of the treatment. If the acid amount of the treatment and reaction time maintain constant, the higher reaction temperature, the lower the viscosity of the starch becomes. In view of the cost of processing, proper conditions for the acid amount of the treatment, reaction temperature and reaction time may be selected. However, the reaction temperature should be set below the temperature at which starch is not gelatinized. If a reaction is carried out at above gelatinization temperature, subsequent processes—washing and dehydration—cannot be carried out since the starch is gelatinized.

The acid amount of the treatment may be 0.1-1 part by weight based on 100 parts by weight of the dry weight of the starch. If the acid amount of the treatment is less than 0.1 part by weight, the hydrolysis takes too much time. If the acid amount of the treatment is greater than 1 part by weight, the reaction time is shortened, but there is a problem of needing to neutralize and wash the acid that remains after reaction. Preferably, the acid amount of the treatment may be 0.4-0.6 part by weight based on 100 parts by weight of the dry weight of the starch, and the reaction time may be 3-6 hours.

The reaction temperature may be from room temperature to less than gelatinization temperature. Gelatinization temperature varies depending on the starch source. For example, corn starch is 75-80° C., waxy corn starch is 65-70° C., and tapioca starch is 60-65° C. If the reaction temperature is lower than room temperature, the reaction may be too slow, and a separate cooling system is needed. If the reaction temperature is above gelatinization temperature, subsequent processes—washing and dehydration of starch—cannot be carried out since the starch is gelatinized. Preferably, the reaction temperature may be 30-60° C., more preferably 35-45° C.

The present invention may further comprise the step of bleaching to impart a whitening effect on the acid-treated starch. For the whitening effect, a general bleaching agent such as sodium metabisulfite, hydrogen peroxide, sodium hypochlorite and the like may be used. Preferably, sodium metabisulfite may be used as a bleaching agent. Sodium metabisulfite is a kind of additive used for discoloring general dyes and chromogenic substances in food processing and for inhibiting change such as browning, coloring and the like in food storage. The treating amount of sodium metabisulfite may be 0.01-2 parts by weight based on 100 parts by weight of the dry weight of the starch, and preferably 1 part by weight or less. If the treating amount of sodium metabisulfite is greater than 2 parts by weight, excess sodium metabisulfite may change pH and generate gas in subsequent processes. In the subsequent reduction step, reduction by adding hydrogen may improve the thermostability and whiteness of the hydrolyzed starch, but the bleaching step can augment the above effects.

Reduction Step

The method for preparing hydroxyalkyl starch according to the present invention comprises the step of reducing the hydrolyzed starch.

The reduction step may be carried out by adding hydrogen gas generated from a reducing agent to the starch. A reducing agent is a material which is oxidized and reduces a counterpart in a reduction-oxidation reaction. For example, sodium borohydride, hydrogen, sulfur dioxide or a mixture thereof may be used as a reducing agent. In view of convenience of use and equipment, sodium borohydride is preferable. By the reduction step in which hydrogen is added to an aldehyde group, stability and thermostability can be improved.

The amount of reducing agent may be 0.1-1 part by weight based on 100 parts by weight of the dry weight of the starch. If the amount of the reducing agent is less than 0.1 part by weight, the addition of hydrogen may be insufficient. If the amount of the reducing agent is greater than 1 part by weight, too much hydrogen gas may be generated.

To regulate the hydrogen gas generation rate via the decomposition of sodium borohydride, the pH of aqueous starch is maintained in a basic state. The reaction temperature is the same as those in the acid treatment. The pH of the aqueous starch may be 8-10. If the pH of the aqueous starch is lower than 8, the regulation of the reaction may be difficult due to vigorous generation of bubbles. If the pH of the aqueous starch is higher than 10, the reaction may be retarded by suppressing hydrogen generation due to the stabilization of sodium borohydride in a highly alkaline condition.

After the reaction is completed by ending the generation of hydrogen gas, the aqueous starch is neutralized to pH 6.0-6.5, washed, dehydrated and dried.

Dry Substitution Step

The method for preparing hydroxyalkyl starch according to the present invention comprises the step of substituting the reduced starch with hydroxyalkyl group in a dry process.

The dry substitution is carried out by drying the reduced starch, treating the dried starch powder with an alkaline catalyst and then etherifying the alkaline catalyst-treated starch.

The alkaline catalyst may be prepared by mixing aliphatic glycol and alkaline solution in a weight ratio of 1:1 to 5:1. The aliphatic glycol may be propylene glycol, ethylene glycol, butylene glycol, diethylene glycol or dipropylene glycol. The alkaline solution may be 50% sodium hydroxide solution or potassium hydroxide solution. The alkaline catalyst may be uniformly dispersed in all the starch with suppressing the gelatinization of the starch granules. The weight ratio may be adjusted according to the water content of the mixture of starch and alkaline catalyst. If the weight ratio is less than 1:1, the starch granules may be gelatinized. If the weight ratio is greater than 5:1, agglomeration of the mixture may occur.

The alkaline catalyst may be added to the reduced starch in an amount of 2-5 parts by weight on the basis of 100% pure alkali (sodium hydroxide or potassium hydroxide) based on 100 parts by weight of the dry weight of the starch. If the amount of alkaline catalyst is less than 2 parts by weight, the hydroxy group of starch may not be sufficiently activated. If the amount of alkaline catalyst is greater than 5 parts by weight, neutralization may be needed due to the excess of alkaline catalyst, and there may be too much undesirable ash.

The water content of the mixture of starch and alkaline catalyst may be 10-20 parts by weight based on 100 parts by weight of the dry weight of the starch. If the water content is less than 10 parts by weight, the reaction may be slowed. If the water content is greater than 20 parts by weight, the excessive water may cause an agglomeration of the reactant, and a re-dehydration process may be necessary.

Hydroxyalkyl starch (modified starch) may be prepared by the reaction of the alkaline catalyst-treated starch with alkylene oxide to highly substitute the starch with hydroxyalkyl group via etherification. By high substitution with hydroxyalkyl group, hydroxyalkyl starch—which has improved thermostability and stability, and is soluble in cold water—can be prepared. The example of the hydroxyalkyl starch includes, but is not limited to, hydroxypropyl starch, hydroxyethyl starch or hydroxybutyl starch.

For example, the hydroxypropyl starch may be prepared by the reaction of the alkaline catalyst-treated starch with propylene oxide. The reaction may be carried out under the pressure of 0-1.5 kg/cm² at 40-60° C. for 5-15 hours. The hydroxypropyl starch has the effect of preventing retrogradation in which starch becomes hard by evaporating water, and improving cold-water solubility and adhesion by lowering gelatinization temperature. In addition, propylene oxide—which is used for adding propyl group—is industrially useful since it can be handled more safely than ethylene oxide due to its low ignition point.

The adding amount of alkylene oxide may be 10-50 parts by weight based on 100 parts by weight of the dry weight of the starch. If the adding amount of alkylene oxide is less than 10 parts by weight, the property of dissolving in cold water may deteriorate. If the adding amount of alkylene oxide is greater than 50 parts by weight, agglomeration of the reactant may result.

In case starch is used in the industrial field, viscosity is one of the important physical properties. If low viscosity is required, starch may be hydrolyzed via acid treatment to decrease the viscosity of starch and improve fluidity. However, the presence of aldehyde group at the terminal of the hydrolyzed starch makes the starch unstable so that browning may occur and the physical properties of the starch may deteriorate. According to the present invention, the aldehyde group is reduced by adding hydrogen to the terminal group, and then the reduced terminal group is substituted with hydroxyalkyl group. As a result, hydroxyalkyl starch—which can adjust viscosity depending on its use, and has improved color and physical properties such as viscosity stability of gelatinized solution, thermostability and alkali resistance—can be prepared. Specifically, the hydroxyalkyl starch has excellent thermostability and color improvement, so that the whiteness of the hydroxyalkyl starch itself can be improved. In addition, the gelatinized solution prepared from the hydroxyalkyl starch has no problem such as color change and viscosity instability even when it is heated at high temperature for a long time. As a result, the hydroxyalkyl starch according to the present invention can be applied in various uses such as an adhesive or a thickener.

### Examples

In the examples, whiteness was measured by using a whiteness tester (Kett, C-100). Tungsten light source and blue filter were used, and the whiteness value of a whiteness calibration plate was set at 86.0. Then, the powder sample of hydroxyalkyl starch was placed in a sample cell and measured. The color index of starch in liquid state which is practically applied was observed with the naked eye. The results are shown in color photographs.

Viscosity was measured by using a Brookfield viscometer (Brookfield, LVT Dial Reading Viscometer). After preparing 20% starch solution (based on starch solid powder), the starch solution was heated at 80° C. for 30 minutes, cooled at 25° C. for 30 minutes, and then viscosity was measured with a Brookfield viscometer #4 spindle at 6 rpm. Agitation speed at dissolving, heating and cooling of the gelatinized solution was constantly maintained at 600 rpm. When measuring viscosity, rpm of the viscometer is an important factor which causes fluctuation of measured values. If rpm exceeds 6, the gelatinized solution may ascend through a spindle and make it difficult to accurately measure viscosity. Thus, rpm of the viscometer was fixed at 6.

According to the examples of the present invention, the viscosity of starch can be controlled in the range below the intrinsic viscosity of starch and can be maintained constantly. Although the viscosity range of starch according to the examples of the present invention is not limited to a specific scope, it is confirmed that adhesive strength or stability of starch is excellent in the range of 5,000-20,000 cps at the time of applying it as a starch binder.

### Example 1

To measure the viscosity change of hydroxypropyl starch according to acid treatment, hydroxypropyl starch was prepared from starch in which viscosity was controlled by acid treatment, and then the viscosity change of each sample was measured.

3,000 g of waxy corn starch (Samyang Genex Corporation, 12 wt % of water content) was treated with hydrochloric acid (35%, Duksan Pure Chemicals Co., Ltd.) in various times and treating amounts, and other processes were carried out under the same conditions. The reaction temperature of acid treatment was maintained at 40° C., and after the reaction with acid for the time of each sample, the pH of aqueous starch was adjusted to 9. After treatment with 66 g of 20% sodium borohydride (98%, Samchun Chemical) solution for 15 hours, the resultant was neutralized to pH 6.2, washed, de-hydrated and dried. 50 g of the catalyst—which was prepared by mixing 50% (w/v) sodium hydroxide and propylene glycol in the weight ratio of 1:2.5—was added to 2,000 g of the reduced starch, and then 320 g of propylene oxide (99%, Acros Organics) was added thereto and reacted at 50° C. for 8 hours to obtain hydroxypropyl starch.

The viscosity of the reduced starch after acid treatment and the viscosity of starch which was substituted with hydroxypropyl group were measured according to the above method. The results are represented in Table 1. From the results, it can be known that the final viscosity of starch substituted with hydroxypropyl group is changed according to the viscosity of the acid-treated starch. Hydroxypropyl starch controllable for viscosity can be prepared by altering the acid amount of the treatment and treating time depending on the viscosity range. As such, hydroxypropyl starch having the viscosity range applicable to various fields can be prepared.

TABLE 1

| | | Acid- | | Acid- | |
|---|---|---|---|---|---|
| | | treating | | treated | Hydroxypropyl |
| | | amount | Treating | starch | starch |
| | | (part by | time | viscosity | viscosity |
| Test sample | | weight) | (hr) | (cps) | (cps) |
| Comparative Example 1 | | — | — | — | 28,000 |
| Example 1 | Sample 1 | 0.6 | 4 | 17,500 | 12,000 |
| | Sample 2 | 0.6 | 3 | 23,000 | 16,000 |
| | Sample 3 | 0.4 | 6 | 13,500 | 10,500 |
| | Sample 4 | 0.4 | 4 | 23,000 | 15,000 |

### Example 2

To determine a bleaching effect according to the treatment of sodium metabisulfite on the acid-treated starch, the whiteness of starch prepared with changing the treating amount and treating time of sodium metabisulfite was measured.

Starch was dissolved in water and maintained at 43° C. Then, the starch was treated with 0.4 part by weight of hydrochloric acid (35%, Duksan Pure Chemicals Co., Ltd.) based on 100 parts by weight of the dry weight of the starch for 4 hours and with 1 part by weight of sodium metabisulfite (98%, Samchun Chemical) based on 100 parts by weight of the dry weight of the starch. The whiteness of the sample collected hourly was measured. The results are represented in Table 2.

TABLE 2

| | Sodium metabisulfite | |
|---|---|---|
| Test sample | treating time (hr) | Whiteness |
| Comparative Example 2 | No treatment | 93.5 |

| | | | |
|---|---|---|---|
| Example 2 | Sample 5 | 1 | 95.0 |
| | Sample 6 | 2 | 95.3 |
| | Sample 7 | 3 | 95.5 |
| | Sample 8 | 4 | 96.0 |
| | Sample 9 | 5 | 96.1 |

Starch was dissolved in water and maintained at 43° C. Then, the starch was treated with 0.4 part by weight of hydrochloric acid (35%, Duksan Pure Chemicals Co., Ltd.) based on 100 parts by weight of the dry weight of the starch for 4 hours and with sodium metabisulfite (98%, Samchun Chemical) within the range of 0.2-1 part by weight based on 100 parts by weight of the dry weight of the starch for 2 hours. After adjusting the pH of aqueous starch to 9, the resultant was treated with 0.5 part by weight sodium borohydride (98%, Samchun Chemical) for 15 hours, neutralized to pH 6.2, washed, dehydrated and dried. The whiteness of the prepared samples was measured, and the results are represented in Table 3.

TABLE 3

| | | Sodium metabisulfite treating | |
|---|---|---|---|
| Test sample | | amount (part by weight) | Whiteness |
| Comparative Example 3 | | Waxy corn starch | 94.8 |
| Comparative Example 4 | | Acid-treated starch | 93.4 |
| Example 2 | Sample 10 | 0.2 | 95.5 |
| | Sample 11 | 0.4 | 95.6 |
| | Sample 12 | 0.6 | 95.4 |
| | Sample 13 | 0.8 | 96.1 |
| | Sample 14 | 1.0 | 96.3 |

From the above results, it can be known that the whiteness of starch is improved if the treatment of sodium metabisulfite is conducted after a hydrolysis step. Whiteness is an important item in starch color control and is usually required to have a value above the requested level. Specifically, if the whiteness of starch is above 95, there is an advantage of it freely being used such as an adhesive or thickener in a wide variety of industrial fields.

### Example 3

After treatment with sodium metabisulfite, aldehyde group at the terminal of starch was reduced by treatment with sodium borohydride. By measuring the whiteness at each hour of treating time of sodium borohydride, the stability of the starch was indirectly tested.

All test samples were treated with 0.6 part by weight of hydrochloric acid based on 100 parts by weight of the dry weight of the starch for 3 hours and with 1 part by weight of sodium metabisulfite based on 100 parts by weight of the dry weight of the starch for 4 hours. Then, Samples 15 to 19 were treated with 0.5 part by weight of sodium borohydride based on 100 parts by weight of the dry weight of the starch for 3, 6, 9, 12 and 15 hours, respectively, and the whiteness of the test samples was measured. The results are represented in Table 4.

TABLE 4

| | Sodium borohydride | |
|---|---|---|
| Test sample | treating time (hr) | Whiteness |
| Comparative Example 5 | No treatment | 95.4 |

| | | | |
|---|---|---|---|
| Example 3 | Sample 15 | 3 | 96.2 |
| | Sample 16 | 6 | 96.7 |
| | Sample 17 | 9 | 96.8 |
| | Sample 18 | 12 | 96.6 |
| | Sample 19 | 15 | 97.2 |

### Example 4

To determine the effect on improving physical properties for thermostability and alkali resistance on each step of the preparation process, the gelatinized solutions were prepared from the hydrolyzed starch, the bleached starch and the reduced starch in an alkaline condition (pH 12-13), and heated at a 95° C. constant temperature water bath for 15 hours. Colors before and after heating were compared.

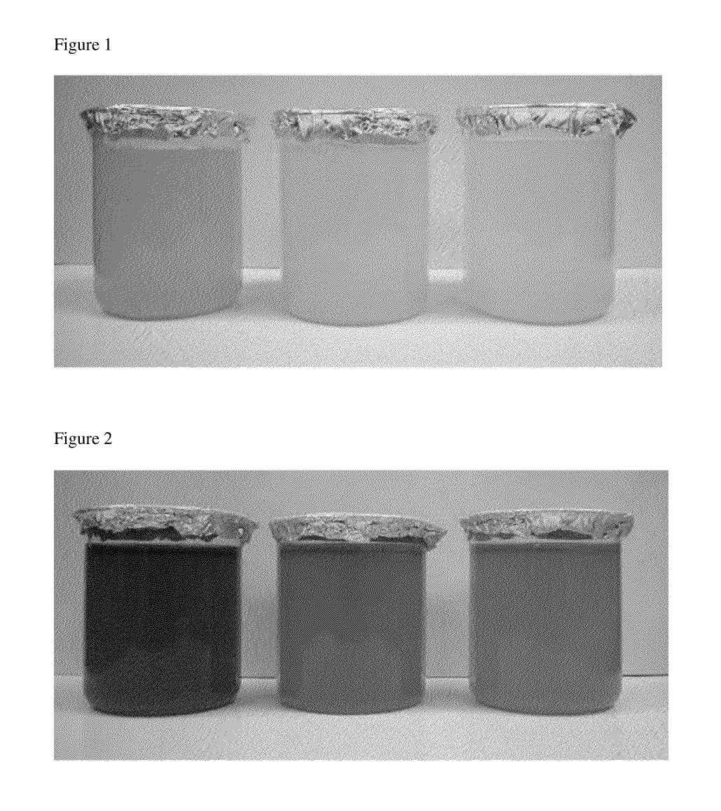

FIG. 1 shows the color of hydrolyzed starch, the bleached starch and the reduced starch before heating, and FIG. 2 shows the color after heating. In FIGS. 1 and 2, the hydrolyzed starch is on the left, the bleached starch is in the middle, and the reduced starch is on the right.

As can be seen from FIGS. 1 and 2, when starch was hydrolyzed by acid treatment, the thermostability and alkali resistance of the starch were drastically deteriorated, but lowering of physical properties can be improved via bleaching treatment and reduction treatment.

In addition, hydroxypropyl starches were prepared from waxy corn starch and modified waxy corn starch—which were hydrolyzed, bleached and reduced in the same condition, and then gelatinized solutions were prepared from each starch. The prepared gelatinized solutions were heated in a 95° C. constant temperature water bath for 15 hours, and colors before and after heating were compared.

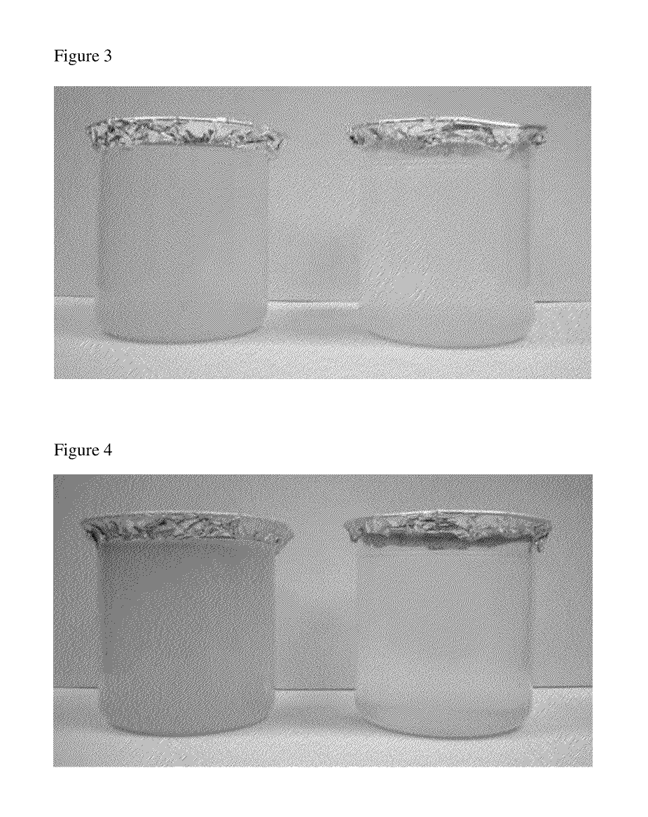

FIG. 3 shows the color of hydroxypropyl starch prepared from waxy corn starch and modified waxy corn starch before heating, and FIG. 4 shows the color after heating. In FIGS. 3 and 4, hydroxypropyl starch prepared from waxy corn starch is on the left, and hydroxypropyl starch prepared from modified waxy corn starch is on the right.

The viscosity of waxy corn starch is 27,000 cps, and that of modified waxy corn starch is 13,000 cps. In the case of modified waxy corn starch, physical properties may have deteriorated due to hydrolysis in adjusting the viscosity. However, as can be seen from FIGS. 3 and 4, physical properties are improved via bleaching and reduction treatment so that hydroxypropyl starch prepared from modified waxy corn starch shows better thermostability and alkali resistance compared with starch.

The present invention and its embodiments have been described in detail herein. A person skilled in the art could understand that the present invention may be embodied as a modified form within the scope of the nature of the present invention. Therefore, the disclosed examples should be considered from an explanatory viewpoint and not a limitative viewpoint. The scope of the present invention is shown in the claims and not in the aforesaid explanation. All differences within the scope equivalent thereto must be interpreted as being included in the present invention.

1. A method for preparing hydroxyalkyl starch comprising the steps of:
hydrolyzing a starch;
reducing the hydrolyzed starch; and
substituting the reduced starch with hydroxyalkyl group in a dry process.

2. The method for preparing hydroxyalkyl starch according to claim 1, wherein the hydrolysis is carried out by an acid treatment.

3. The method for preparing hydroxyalkyl starch according to claim 2, wherein the acid is selected from hydrochloric acid, sulfuric acid, oxalic acid and a mixture thereof; and the acid amount of the treatment is 0.1-1 part by weight based on 100 parts by weight of the dry weight of the starch.

4. The method for preparing hydroxyalkyl starch according to claim 1, which further comprises the step of bleaching the hydrolyzed starch prior to the reduction step.

5. The method for preparing hydroxyalkyl starch according to claim 4, wherein the bleaching is carried out by treatment with one or more selected from the group consisting of sodium metabisulfite, hydrogen peroxide and sodium hypochlorite.

6. The method for preparing hydroxyalkyl starch according to claim 1, wherein the reduction is carried out by adding a hydrogen gas generated from a reducing agent to the starch.

7. The method for preparing hydroxyalkyl starch according to claim 6, wherein the reducing agent is selected from sodium borohydride, hydrogen, sulfur dioxide and a mixture thereof; and the amount of reducing agent is 0.1-1 part by weight based on 100 parts by weight of the dry weight of the starch.

8. The method for preparing hydroxyalkyl starch according to claim 1, wherein the substitution in the dry process is carried out by drying the reduced starch, treating the dried starch with an alkaline catalyst, and etherifying the alkaline catalyst-treated starch.

9. The method for preparing hydroxyalkyl starch according to claim 8, wherein the alkaline catalyst is prepared by mixing an aliphatic glycol and an alkaline solution in a weight ratio of 1:1 to 5:1.

10. The method for preparing hydroxyalkyl starch according to claim 9, wherein the aliphatic glycol is selected from propylene glycol, ethylene glycol, butylene glycol, diethylene glycol and dipropylene glycol, and the alkaline solution is 50% sodium hydroxide solution or potassium hydroxide solution.
